(19) United States
(12) Patent Application Publication
(10) Pub. No.: US 2006/0225115 A1
(43) Pub. Date: Oct. 5, 2006

(54) Systems and methods for network communication

(75) Inventors: Peter T. Barrett, San Francisco, CA (US); Gandhimathi Vaithilingam, Sunnyvale, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/097,971

(22) Filed: Apr. 1, 2005

(51) Int. Cl. H04N 7/173

(52) U.S. Cl. 725/113; 725/110; 725/112

(57) ABSTRACT

Systems and methods for communication of content over a network are described. In an implementation, a method is described which includes mapping a network address of a request for content to a multicast address and determining if the requested content is available via the multicast address. If not, the request is communicated to a content provider that is configured to provide the content for communication via multicast address.

### TECHNICAL FIELD

The present invention generally relates to networks and more particularly relates to systems and methods for communication of content over a network.

### BACKGROUND

Television viewers are exposed to an ever increasing variety of content. For example, a television viewer may access hundreds of broadcast channels to view movies and television programs, listen to music broadcasts, and so on. Additionally, the television viewer may have access to video-on-demand (VOD) and pay-per-view (PPV) events, such as movies and sporting events. A variety of other content may also be made available to the television viewer, such as video games and so forth.

The variety of content that may be provided to the television viewer, however, may be limited by traditional television systems which are utilized to provide the content. For example, a traditional television system may provide limited amounts of bandwidth for communication by the television viewer back to the traditional television system, which thereby limits the amount and types of content that may be provided to the television viewer.

Additionally, the traditional television system may include proprietary techniques to prevent unauthorized access to the content. However, these proprietary techniques may also limit providers of devices (e.g., set-top boxes) and applications (e.g., online games) from being used by the television system. For instance, an application creator for a set-top box may be confronted with a vast number of different proprietary techniques which are utilized by different television systems. These different techniques previously required the creation of specific applications for use on each different television system, which may be expensive in both time and resources for a creator of the application. Therefore, the application creator may choose to forgo providing the application altogether, which results in a decrease in functionality that is available to the television viewer and lost revenue opportunities to both the application creator and the television system.

Therefore, there is a continuing need for improved techniques for communicating content over a network.

### SUMMARY

Systems and methods for communication of content over a network are described. In an implementation, a method is described which includes mapping a network address of a request for content to a multicast address and determining if the requested content is available via the multicast address. If not, the request is communicated to a content provider that is configured to provide the content for communication via the multicast address.

In another implementation, a method includes receiving a request for content that is available via a network address specified in the request, mapping the network address to a multicast address, and making the content available via the multicast address.

In a further implementation, a system includes a proprietary network, one or more modules, and at least one module. The one or more modules are executable to translate requests for content received from an application module for transfer over a proprietary network such that the application module is not aware of the translation. The at least one module is executable to translate the translated requests received via the proprietary network for use by an application server module to obtain the content such that the application server module is not aware of the translation.

### BRIEF DESCRIPTION OF THE DRAWINGS

FIG. 1 is an illustration of an environment in an exemplary implementation that is operable to employ techniques for communication over a proprietary network.

FIG. 2 is an illustration of a system in an exemplary implementation showing a server side and a client of FIG. 1 as implemented by a plurality of computing devices.

FIG. 3 is a flow diagram depicting an exemplary implementation in which a procedure is performed in the system of FIG. 2 to provide a particular content item via a multicast address.

FIG. 4 is a flow diagram depicting a procedure in an exemplary implementation in which a client first examines a multicast address to determine if content is available at that address before requesting content from a content server.

FIG. 5 is a flow diagram depicting a procedure in an exemplary implementation in which a determination is made as to whether a content item is public or private and the content item is communicated over the proprietary network accordingly.

The same reference numbers are utilized in instances in the discussion to reference like structures and components.

### DETAILED DESCRIPTION

Overview

Systems and methods for communication over a proprietary network are described. Traditional television systems may limit the amount of functionality that may be provided to a user. For example, a traditional television system may be configured primarily as a one-way network to broadcast content to the user. Although the network may support “backchannel” communication from the user back to a broadcaster of the content, this communication is generally limited to relatively low amounts of bandwidth. In another example, the traditional television system may support proprietary techniques which are particular to that television system, such as encryption, data transfer formats and techniques, and so on. Therefore, each application and device which was to be utilized on such a system was typically configured to address these specific proprietary techniques.

In one or more implementations, techniques are described in which a television system employs one or more modules to deliver two-way services in a proprietary network that is configured, primarily, to provide generally one-way services. For example, when a client (e.g., a client device such as a personal computer) requests data from the network, the request may be converted to a uniform resource locator (URL) request. The URL is then converted to a multicast address to determine if the URL requested has previously been made available in a multicast format. If not, the request is passed to an IP gateway, which retrieves the data. The IP gateway may be configured to determine whether the data is to be provided via a private address (e.g., a unicast address) or a public address (e.g., a multicast address) depending on the user's request, such as whether the request is for public information (e.g., a news webpage) or private information (e.g., a banking webpage).

The client may be configured to periodically check the multicast address to determine whether the response has been received. Thus in this implementation, one client may “take advantage” of requests may by other clients for the same content, thereby conserving the “upstream” resources of the network from the clients to the content provider. A variety of other implementations are also contemplated, further discussion of which may be found in relation to the following sections. In the following discussion, an exemplary environment is first described which is operable to employ a variety of communication techniques. Exemplary procedures are then described which may be implemented in the exemplary environment, as well as in other environments.

### Exemplary Environment

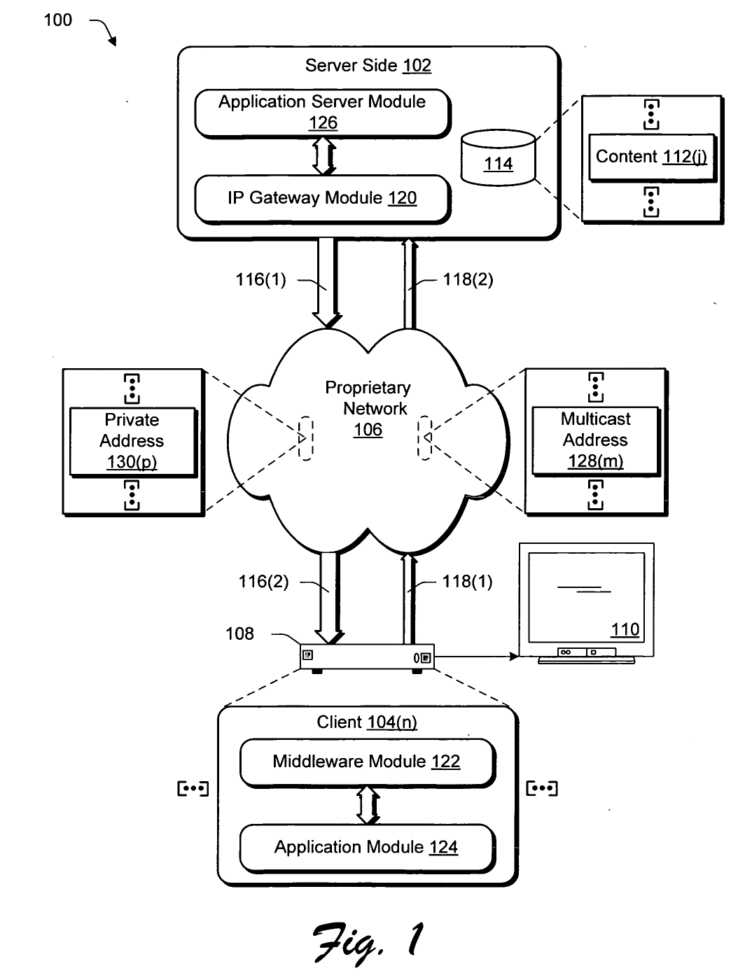

FIG. 1 is an illustration of an environment 100 in an exemplary implementation that is operable to employ techniques for communication over a proprietary network. The illustrated environment 100 includes a server side 102 which is communicatively coupled to a plurality of clients 104(n), where “n” can be any integer from one to “N”, over a proprietary network 106. The clients 104(n) may assume a wide variety of configurations. For example, one or more of the clients 104(n) may be configured as a computing device, such as a desktop computer, a mobile station, an entertainment appliance, a set-top box 108 communicatively coupled to a display device 110 as illustrated, a wireless phone, a game console, and so forth. Thus, the clients 104(n) may range from full resource devices with substantial memory and processor resources (e.g., personal computers, game consoles) to low-resource devices with limited memory and/or processing resources (e.g., traditional set-top boxes, hand-held game consoles). The clients 104(n) may also relate to a person and/or entity that operate the clients. In other words, one or more of the clients 104(n) may describe logical clients that include users, software, and/or devices.

The server side 102 may be configured in a wide variety of ways to provide a wide variety of functionality. For example, the server side 102 is illustrated in FIG. 1 as including a plurality of content 112(j), where “j” can be any integer from 1 to “J”, which is illustrated as stored in a database 114. The content 112(j) may include a variety of data, such as streaming content (e.g., television programming and pay-per-view movies), one or more results of remote application processing, electronic program guide (EPG) data, broadcast television programs, and so on.

The content 112(j) may be obtained by the server side 102 in a variety of ways. The server side 102, for example, may be configured as a content provider which provides the content 112(j) for distribution by a head end to the plurality of clients 104(n). In another example, the server side 102 may be configured as a head end which receives the content 112(j) from a content provider for distribution over the proprietary network 106. A variety of other examples are also contemplated without departing from the spirit and scope thereof.

The proprietary network 106 may be configured in a variety of ways to communicatively couple the server side 102 to the client 104(n), such as a broadcast television network that is configured to broadcast content to the client 104(n). For example, the proprietary network 106 is illustrated as supporting communication from the server side 102 to the client (as illustrated by arrows 116(1), 116(2)) for distribution of content 112(j). The proprietary network 106 also supports communication from the client 104(n) to the server side 102, as illustrated by arrows 118(1), 118(2). For example, the client 104(n) may form one or more requests for a particular content item and communicate that request over the proprietary network via a backchannel represented by arrows 118(1), 118(2).

The bandwidth that is available for communication from the server side 102 to the client 104(n) (e.g., arrows 116(1), 116(2)), however, may be significantly greater than the bandwidth which is available from the client 104(n) to the server side (e.g., arrows 118(1), 118(2)). The relative amounts of bandwidth are illustrated in FIG. 1 through the relative sizes of the arrows, such as by comparing arrows 116(1), 116(2) with arrows 118(1), 118(2). Therefore, the proprietary network 106 illustrated in the environment 100 of FIG. 1 is configured primarily as a one-way network to communicate content 112(j) to the user, and also supports “backchannel” communication from the client 104(n) back to the server side 102.

The proprietary network 106 may also support a variety of communication techniques which are particular to the proprietary network 106. For example, the proprietary network 106 may support encryption techniques to prevent unauthorized distribution of the content 112(j), such as through the use of encryption and decryption keys with encryption and decryption algorithms. The proprietary network 106 may also support data compression techniques to compress the content 112(j) for distribution through the proprietary network 106. The proprietary network 106 may support a variety of other proprietary techniques, such as particular data formats, mapping techniques, and so forth.

To provide for communication over the proprietary network 106, the server side is illustrated as including an internet protocol (IP) gateway module 120 and the client 104(n) is illustrated as including a middleware module 122. The IP gateway module 120 and the middleware module 122 are executable to translate communications such that the translated communications are in compliance (i.e., suitable) for transfer over the proprietary network 106. In this way, the IP gateway module 120 and the middleware module 122 may enable other modules to communicate over the proprietary network 106 that otherwise would not be able to do so. Thus, creators of modules may provide a “generic” module that is not aware of the particulars of the proprietary network 106.

The client 104(n), for instance, may include an application module 124 which is executable to form a request for content. The request is translated by the middleware module 122 for communication over the proprietary network (e.g., arrows 118(1), 118(2)) to the IP gateway module 120. The IP gateway module 120 is also executable to translate the request into a form that is understood by the application server module 126, which may be the same as or different from the format of the original request provided by the application module 124 of the client 104(n).

The application server module 126 is executable to manage the plurality of content 112(j), such as to create the content 112(j), process requests for previously configured content 112(j), and so on. For instance, the application server module 126 may obtain content 112(i j) referenced by the request for communication to the client 104(n) over the proprietary network 106.

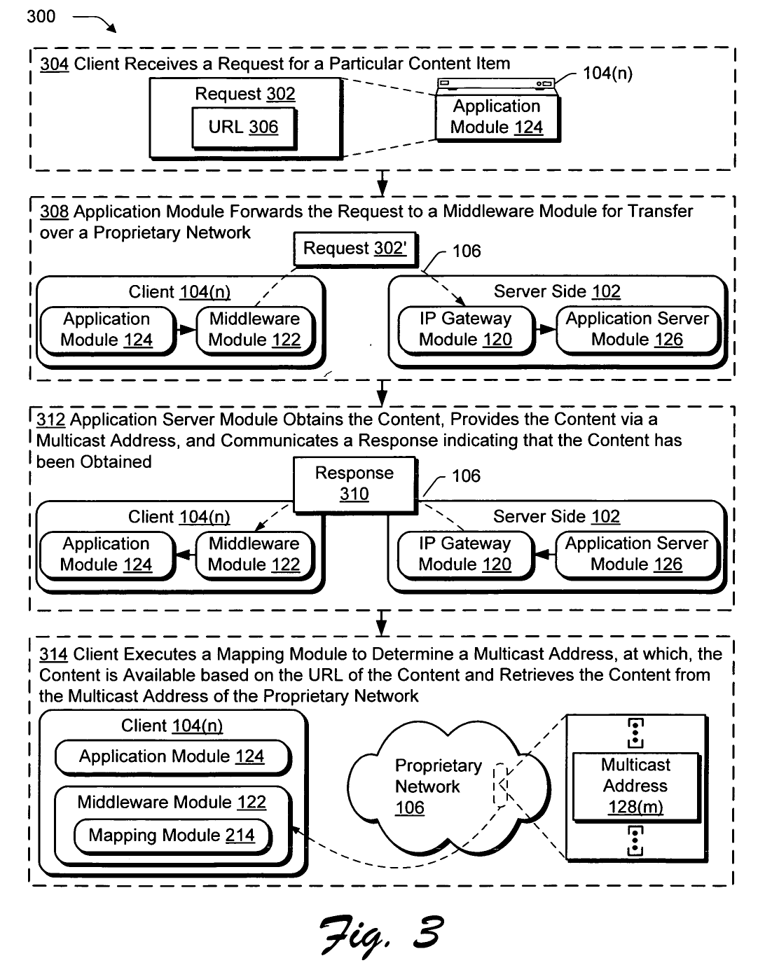

The content 112(j) may be communicated in a variety of ways. For instance, the application server module 126, through the IP gateway module 120, may make the content 112(j) available via one of a plurality of multicast addresses 128(m), where “m” can be any integer from one to “M”. Multicast is generally considered a communication technique in which a communication (e.g., the content 112(j)) is communicated from a single sender (e.g., the server side 102) to multiple recipients (e.g., the clients) over a network, which in this case is the proprietary network 106. In an implementation, the multicast addresses 128(m) are “public”, meaning that each of the plurality of clients 104(n) may access each of the plurality of multicast addresses 128(m). This technique may be utilized to provide a variety of functionality. For example, a request made by one of the clients 104(n) for the particular content item 112(j) may be leveraged by another one of the clients 104(n) such that a request from the other client need not be communicated to the server side 102. Rather, the other client may merely “look” at the multicast address 128(m) to obtain the content, further discussion of which may be found in relation to FIG. 3.

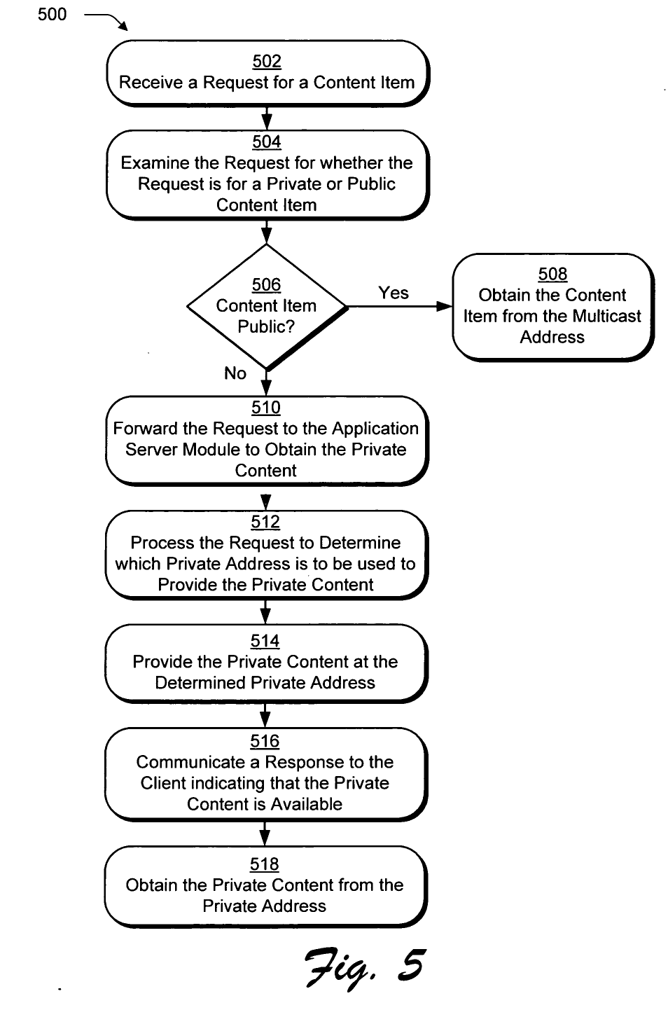

The application server module 126, through the IP gateway module 120, may also make the content 112(j) available via one of a plurality of private addresses 130(p), where “p” can be any integer from one to “P”. For example, one or more of the private addresses 130(p) may be configured as a “unicast” address. A unicast address is provided for communication from a single sender (e.g., the server side 102) to a single recipient (e.g., a particular one of the plurality of clients 104(n)) over the proprietary network 106. In this way, sensitive content that is particular to the client 104(n) may be protected from unauthorized access. For example, the client 104(n) may request content 112(j) from the server side 102 which describes banking account information of the client 104(n). Rather than provide this sensitive content at a multicast address 128(m) such that other ones of the plurality of clients 104(n) may access the content, the server side 102 may provide the content to the client 104(n) via one or more of a plurality of private addresses 130(p) which are particular to the client 104(n), such as a MAC address for the particular client 104(n). Further discussion of “private” content communication via private addresses may be found in relation to FIG. 5.

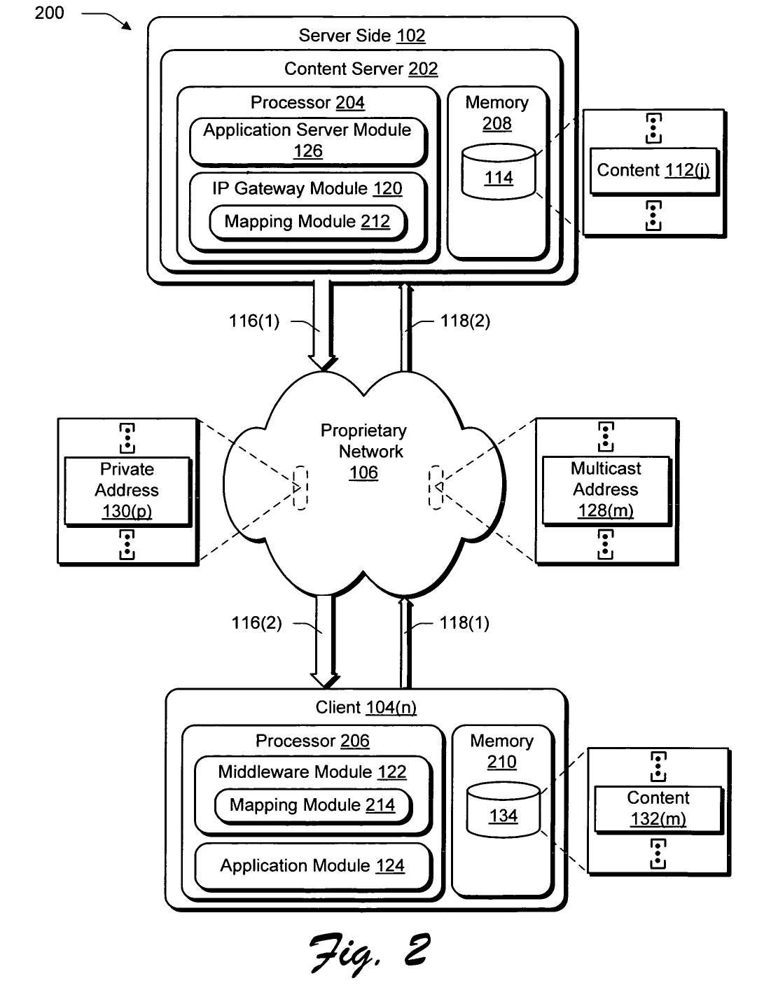

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the communication techniques described below are platform-independent, meaning that the techniques may be implemented on a variety of commercial computing platforms having a variety of processors.

FIG. 2 is an illustration of a system 200 in an exemplary implementation showing the server side 102 and the client 104(n) of FIG. 1 as implemented by a plurality of computing devices. The server side 102 is illustrated as implemented by a content server 202 and the client 104(n) is illustrated as a client device. The content server 202 and the client 104(n) are further illustrated as including a respective processor 204, 206 and a respective memory 208, 210. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 208, 210 is shown, respectively, for the content server 202 and the client 104(n), a wide variety of types and combinations of memory may be employed, such as random access memory (RAM), hard disk memory, removable medium memory, and so forth.

The content server 202 is illustrated as executing the application server module 126 and the IP gateway module 120 on the processor 204, which are also storable in memory 208. As previously described, the application server module 126 is executable to manage the plurality of content 112(j), which in this instance is illustrated as stored in the memory 208. In this instance, however, the application server module 126 is not configured, by itself, for communication over the proprietary network 106. For example, the proprietary network 106 may utilize encryption, compression, addressing, formatting, and other techniques which are not addressed by the application server module 126. Therefore, the application server module 126 may utilize an IP gateway module 120 to communicate over the proprietary network 106.

The IP gateway module 120 is executable to transfer and translate communications to and from the application server module 126 for communication over the proprietary network 106. For instance, the IP gateway module 120 may receive a request for a particular content item configured for communication over the proprietary network 106. The IP gateway module 120 may then translate the request into a form that is “understandable” by the application server module 126, and transfer a response, if any, from the application server module 126 for communication back over the proprietary network 106. For example, the application server module 126 may be configured to communicate utilizing hypertext transfer protocol (HTTP) compliant communications. The proprietary network 106, however, may not be configured to utilize HTTP compliant communications. Therefore, the IP gateway module 120 may translate the communication into a form that is suitable for transfer over the proprietary network 106. Thus, the application server module 126 is not configured specifically for communication utilizing the proprietary network 106. Indeed, the application server module 126 may not even be “aware” that such translation is even occurring. Thus, the IP gateway module 120 may provide support for execution of a variety of applications on the server side 102.

Likewise, the client 104(n) may include similar functionality through use of a middleware module 122, which is illustrated as being executed on the processor 206 and is storable in memory 210. For instance, the application module 124 may form a request for a particular content item. The middleware module 122 may translate the request into a form that is suitable for communication over the proprietary network 106 for processing by the server side 102 as described in the previous paragraph. The middleware module 122 may also be executable to process a response received from the server side 102 such that it is “understandable” by the application module 124. Continuing with the previous example, the application module 124 may also be configured to communicate utilizing hypertext transfer protocol (HTTP) compliant communications. As previously described, however, the proprietary network 106 may not be configured to utilize HTTP compliant communications. Therefore, the middleware module 122 is utilized to translate communications into a form that is suitable for transfer over the proprietary network 106. Thus, the application module 124 may be “generic” such that it does not need to be specifically configured for communication utilizing the proprietary network 106, nor “aware” that such translation is even occurring.

Although this example described both the application server module 126 and the application module 124 as being HTTP compliant, a wide variety of formats and protocols may be supported by these modules. Additionally, the application server module 126 may utilize protocols and formats which are different than the protocols and formats supported by the application module 124, and vice versa.

The IP gateway module 120 and the middleware module 122 are also illustrated as having a respective mapping module 212, 214. The mapping modules 212, 214 are executable to determine which of the plurality of multicast address 128(m) are to be used to provide the content 112(j). For example, the IP gateway module 120 may receive content 112(j) that was requested from a particular network address. The IP gateway module 120 may then execute the mapping module 212 to process the particular network address to determine which of the plurality of multicast addresses 128(m) are to be utilized to provide the content 112(j).

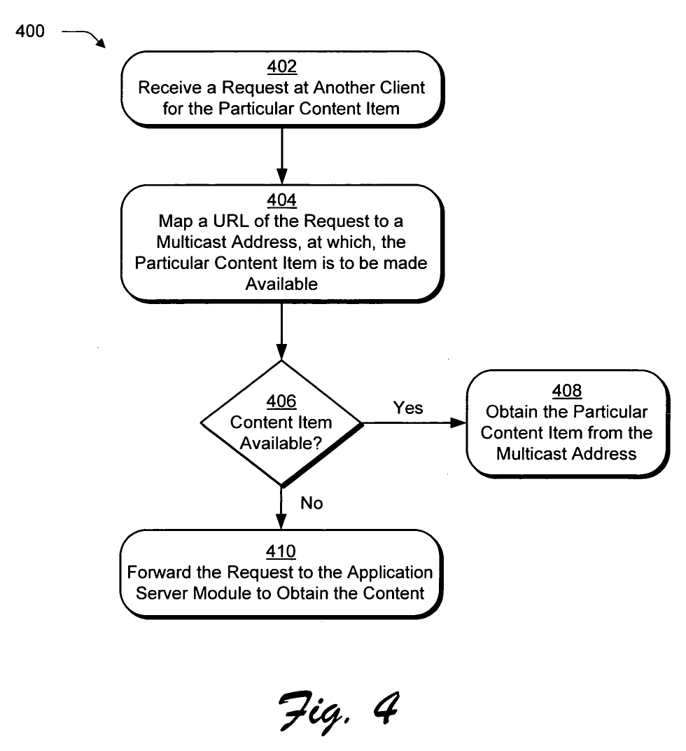

The mapping module 214 of the client 104(n) may also be executed to provide similar functionality. For example, the mapping module 214 may also process the particular network address to locate the multicast address 128(m), at which, the middleware module 122 is to retrieve the content 112(j) obtained by the content server 202. In this way, the middleware module 122, through execution of the mapping module 214, may determine where to find the requested content 112(j) without communicating a specific request for the network address to the server side 102 as was previously required. Thus, the mapping modules 212, 214 may be utilized to conserve the limited amount of bandwidth that is available for backchannel 118(1), 118(2) communication. Further discussion of execution of the mapping modules may be found in relation to FIG. 4.

Similar functionality may also be provided for use with the plurality of private addresses 130(p). For example, the mapping modules 212, 214, when executed, may determine which of the plurality of private addresses 130(p) correspond to the client 104(n), such as a MAC address of the particular client 104(n). A variety of other techniques may also be utilized, further discussion of which may be found in relation to FIG. 5.

Exemplary Procedures

The following discussion describes communication techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

FIG. 3 is a flow diagram depicting an exemplary implementation in which a procedure 300 is performed in the system 200 of FIG. 2 to provide a particular content item via a multicast address. A client 104(n) receives a request 302 for a particular content item (block 304). The request 302 may be received in a variety of ways. For example, the client 104(n) may execute the application module 124 to provide a user interface such that a user of the client 104(n) may specify which content is being requested. The request 302 is illustrated as including a URL 306 which identifies a network location of the requested content.

The application module 124 then forwards the request 302 to a middleware module 122 for transfer over the proprietary network 106 (block 308). The middleware module 122, for instance, may translate the request 302 into a form (illustrated as request 302′) which is suitable for transfer over the proprietary network 106. This translation may utilize a variety of techniques, such as reformatting, compression, encryption, and so forth. Therefore, the request 302, when translated to form request 302′, may not be compatible with the application module 124, i.e., the application module 124 cannot read the request 302′.

The IP gateway module 120 receives the translated request 302′ and translates it into a form that is compatible with the application server module 126. The request, as translated by the IP gateway module 120, may be the same as or different from the original request. For instance, the request 302 may be an HTTP request for a web page located at the URL 306. The request 302 may be translated by the middleware module 122 into a form that is suitable for transport across the proprietary network 106. The IP gateway module 120 may then translate the request back into its original form (e.g., the HTTP request) for processing by the application server module 126. A variety of other instances are also contemplated.

The application server module 126 then obtains the content, provides the content via a multicast address, and communicates a response 310 indicating that the content has been obtained (block 312). For example, the application server module 126 may obtain the content from the URL 306 referenced in the request 302 and provide that content to the IP gateway module 120. The IP gateway module may then map the URL 306 to a particular multicast address 128(m) using the mapping module 212. For example, the mapping module 212 may employ a hashing algorithm to hash the network address (e.g., URL) of the requested content to a particular multicast address 128(m). For instance, the hash value obtained from the URL may map directly to a particular multicast address, may be utilized as an index in a table of multicast addresses, and so on. The IP gateway module 120 may then form and communicate the response 310 back over the proprietary network 106 for receipt by the client 104(n).

The client executes a mapping module to determine a multicast address, at which, the content is available based on the URL of the content and retrieves the content from the multicast address of the proprietary network 106 (block 314). For example, the mapping module 214 of the client 104(n) may also be executed to determine which of the plurality of multicast addresses 128(m) are to be utilized to deliver the requested content, such as by hashing the URL 306 of the requested content. Thus, both mapping modules 212, 214 may employ similar functionality to determine how to transfer the content over the proprietary network 106. Additionally, by applying similar functionality, the client 104(n) does not need to communicate with the server side 102 to locate the content. In other words, the response 310 need not include the location of the content, but rather can be utilized to indicate that the content is available, thereby conserving network resources. Additionally, this technique for locating the content may be leveraged by other clients, further discussion of which may be found in relation to the following figure.

FIG. 4 is a flow diagram depicting a procedure 400 in an exemplary implementation in which a client first examines a multicast address to determine if content is available at that address before requesting content from a content server. A request is received at another client for the particular content item (block 402). For example, another one of the plurality of clients 104(n) may also request the particular content item that was requested by the client of procedure 300 of FIG. 3.

A URL of the request is mapped to a multicast address, at which, the particular content item is to be made available (block 404). For example, the other client may execute a mapping module which employs a hashing algorithm to hash the URL of the requested content to arrive at a hash value. The hash value may then be utilized as an index in a table of multicast addresses to locate a particular multicast address that is to correspond to the URL.

The other client then determines whether the content item is available at the multicast address (decision block 406). If the content item is available (“yes” from decision block 406), the other client obtains the particular content item from the multicast address (block 408). If the content item is not available (“no” from decision block 406), the client forwards the request to the application server module to obtain the content (block 410). For example, the other client may then perform the procedure 300 of FIG. 3 to obtain the content. In this way, the proprietary network 106, through use of the multicast addresses 128(m), may function as an extended cache of content for the plurality of clients 104(n) such that each client may leverage requests made for content by other clients.

A first client, for instance, may request a news webpage from a news website. The news webpage may be provided via the multicast address which is selected by mapping the URL of the web page. Subsequent clients which desire that webpage may also map the URL to first determine whether the news webpage is already available via the multicast address. If the news webpage is not available, then the clients communicate with the server side 102 (through the IP gateway and middleware modules 120, 122) to obtain the content. Thus, communication over the backchannels (e.g., arrows 118(1), 118(2)) of the proprietary network 106 is minimized, thereby conserving network and server side resources. In some instances, however, the requested content item is private, and therefore should not be made available to each of the plurality of clients 104(n). In such instances, the IP gateway and middleware modules 120, 122 may utilize private addresses 130(p), further discussion of which may be found in relation to the following figure.

FIG. 5 is a flow diagram depicting a procedure 500 in an exemplary implementation in which a determination is made as to whether a content item is public or private and is therefore communicated over the proprietary network accordingly. A request is received for a content item (block 502) and the request is examined to determine whether the request is for a private or public content item (block 504). For example, the application module 124 may request a particular content item and set a “flag” in the request which indicates whether the requested content item is public (i.e., may be accessed by other clients) or private, such that the requested content item is accessible only by the requesting client.

Based on the examination (block 504), a determination is made as to whether the requested content item is public (decision block 506). If so (“yes” from decision block 506), the content item is obtained from multicast address (block 508). For example, the procedure 400 of FIG. 4 may be performed to first determine whether the content item is already available via the multicast address by processing the URL of the requested content item. If the content item is not already available, the client may communicate with the server side via the procedure 300 of FIG. 3 to cause the content item to be provided via that multicast address.

If the content item is not public (“no” from decision block 506), the request is forwarded to the application server module to obtain the private content (block 510). For example, the middleware module 122 may translate the request into a form which is suitable for transfer over the proprietary network 106 to the IP gateway module 120. The IP gateway module 120 may then translate the translated request into a form that is compatible with the application server module 126 such that the application server module 126 may obtain the requested content.

The request is processed to determine which private address is to be used to provide the private content (block 512). For example, the request may include an identifier of the client 104(n). Therefore, the IP gateway module 120 may determine which of the plurality of private addresses 130(p) correspond to the client and provide the private content at the determined address (block 514). In another example, the IP gateway module 120 may provide the requested private content via a unicast to a MAC address of the client. A variety of other examples are also contemplated.

The IP gateway module then communicates a response to the client indicates that the private content is available (block 516) and the client obtains the private content from the private address (block 518). In another example, the IP gateway module 120 does not send the response. Therefore, the middleware module 122 may monitor the private address to determine when the private content is available and obtain the private content. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
mapping a network address of a request for content to a multicast address; and
determining if the requested content is available via the multicast address, and if not, communicating the request to a content provider that is configured to provide the content for communication via the multicast address.

2. A method as described in claim 1, wherein the mapping is performed using a hash function.

3. A method as described in claim 1, wherein the network address is configured as a uniform resource locator (URL).

4. A method as described in claim 1, further comprising translating the request such that the translated request is suitable for communication over a proprietary network.

5. A method as described in claim 1, further comprising ascertaining whether the content is public, and if so, performing the mapping.

6. A method as described in claim 5, wherein if the content is not public, communicating the request to the content provider without performing the determining.

7. A method comprising:
receiving a request for content that is available via a network address specified in the request;
mapping the network address to a multicast address; and
making the content available via the multicast address.

8. A method as described in claim 7, wherein the network address is a uniform resource locator.

9. A method as described in claim 7, wherein the receiving, the mapping, and the making are performed by one or more servers and further comprising:
mapping the network address to the multicast address by a client; and
monitoring the multicast address for the content.

10. A method as described in claim 7, wherein the mapping by the client is performed without receiving a communication indicating the multicast address from the one or more servers.

11. A method as described in claim 7, wherein the mapping is performed using a hash function.

12. A method as described in claim 7, further comprising translating the request such that the translated request is suitable for communication over a proprietary network.

13. A system comprising:
a proprietary network;
one or more modules which are executable to translate requests for content received from an application module for transfer over a proprietary network such that the application module is not aware of the translation; and
at least one module which is executable to translate the translated requests received via the proprietary network for use by an application server module to obtain the content such that the application server module is not aware of the translation.

14. A system as described in claim 13, wherein:
the one or more modules are further executable to map network addresses located in the request to corresponding multicast addresses, at which, the content is to be made available; and the at least one module is further executable to map network addresses located in the request to corresponding multicast addresses, at which, the content is to be made available.

15. A system as described in claim 14, wherein the network addresses are mapped using a hashing algorithm.

16. A system as described in claim 15, wherein the hashing algorithm is utilized to arrive at an index for use in a table of network addresses.

17. A system as described in claim 13, wherein the proprietary network is configured to provide television content.

18. A system as described in claim 13, wherein the proprietary network is configured such that requests from the application module to the application server module are communicated over a backchannel.

19. A system as described in claim 18, wherein the backchannel has relatively lower bandwidth available than bandwidth which is available to communicate content from the application server module to the application module.

20. A system as described in claim 13, wherein the one or more modules are executable on a client and the at least one module is executable on a server which is communicatively coupled to the client via the proprietary network.
